(19) United States
(12) Patent Application Publication
(10) Pub. No.: US 2025/0245067 A1
(43) Pub. Date: Jul. 31, 2025

(54) METHOD AND SYSTEM FOR DEPLOYING A WORKLOAD

(71) Applicant: HCL Technologies Limited, NEW DELHI (IN)

(72) Inventors: Abhishek Kumar Srivastava, Noida (IN); Hareendran M, Chennai (IN); Maheswari V. S, Chennai (IN)

(21) Appl. No.: 19/037,134

(22) Filed: Jan. 25, 2025

(30) Foreign Application Priority Data
Jan. 30, 2024 (IN) 202411006181

(51) Int. Cl. G06F 9/50

(52) U.S. Cl. CPC G06F 9/5055

(57) ABSTRACT

The disclosure relates to a method and system of deploying a workload. The method may include assessing a plurality of parameters associated with a workload and a set of sub-parameters associated with each of the plurality of parameters, corresponding to a deployment model selection. The method may further include obtaining a rating assigned to each sub-parameter, determining a sub-parameter weighted score for each sub-parameter, and determining a parameter score for the parameter. The method may further include obtaining a plurality of parameter weighted scores for the plurality of parameters, and combining the plurality of parameter weighted scores for the plurality of parameters, to determine an overall score for the workload. The method may further include comparing the overall score for workload with one or more threshold values, and selecting a deployment model for the deployment of the workload, based on the comparison.

### TECHNICAL FIELD

This disclosure relates generally to deploying workload in High-performance computing, and in particular to a method and a system for selecting a deployment model and a deployment type for a workload.

### BACKGROUND

High-performance computing (HPC) is the use of computers to solve problems that are computationally expensive for traditional computers. HPC systems are used in a variety of fields like simulation, modelling, Finite Element Analysis (FEA), weather forecasting, etc. However, there are no available solutions that can assist an existing HPC system or a new HPC system with respect to generating selections as to whether to opt for cloud, hybrid or on-premise deployment. For example, organizations working on HPC systems face a pivotal decision—whether to embrace the cloud's promise of flexibility, scalability, agility for their HPC needs or maintain their system on-premise with lower latency and good level of control over hardware and software. This decision may further affect cost involved to run the complex system and the operational efficiency to gain competitive edge over others to ensure smooth business continuity. Further, the decision needs comprehensive evaluation, and the organizations need to look at various factors like need for peak performance, catering the peak load requirement, data security, compliance, budget, etc. to decide between cloud, on-premise or hybrid deployment for the workload.

Therefore, there is a need for solutions that provide for effective and efficient solutions for selecting deployment model and deployment type for a workload.

### SUMMARY

In an embodiment, a method of deploying a workload is disclosed. The method may include assessing a plurality of parameters associated with a workload and a set of sub-parameters associated with each of the plurality of parameters associated with the workload, corresponding to a deployment model selection. The method may further include obtaining a rating assigned to each sub-parameter of the set of sub-parameters associated with the parameter, for each parameter of the plurality of parameters, corresponding to the deployment model selection. The method may further include applying an associated weightage value to the rating assigned to each sub-parameter of the set of sub-parameters, to determine a sub-parameter weighted score for each sub-parameter of the set of sub-parameters, for each parameter of the plurality of parameters, corresponding to the deployment model selection. The method may further include combining a set of sub-parameter weighted scores corresponding to the set of sub-parameters, to determine a parameter score for the parameter, for each parameter of the plurality of parameters, corresponding to the deployment model selection. The method may further include applying an associated weightage value to the parameter score of each of the plurality of parameters, to obtain a plurality of parameter weighted scores for the plurality of parameters, respectively. The method may further include combining the plurality of parameter weighted scores for the plurality of parameters, to determine an overall score for the workload, and comparing the overall score for workload with one or more threshold values. The method may further include selecting a deployment model for the deployment of the workload, based on the comparison. The deployment model may be one of: an on-premise deployment model, a hybrid deployment model, and a cloud deployment model.

In another embodiment, a system for deploying a workload is disclosed. The system includes a processor and a memory communicatively coupled with the processor. The memory stores processor-executable instructions, such that the processor-executable instructions, upon execution by the processor, cause the processor to: assess a plurality of parameters associated with the workload and a set of sub-parameters associated with each of the plurality of parameters associated with the workload, corresponding to a deployment type selection. The processor-executable instructions further cause the processor to obtain a rating assigned to each sub-parameter of the set of sub-parameters associated with the parameter, for each parameter of the plurality of parameters, corresponding to the deployment type selection. The processor-executable instructions further cause the processor to apply an associated weightage value to the rating assigned to each sub-parameter of the set of sub-parameters, to determine a sub-parameter weighted score for each sub-parameter of the set of sub-parameters, for each parameter of the plurality of parameters, corresponding to the deployment type selection. The processor-executable instructions further cause the processor to combine a set of sub-parameter weighted scores corresponding to the set of sub-parameters, to determine a parameter score for the parameter, for each parameter of the plurality of parameters, corresponding to the deployment type selection. The processor-executable instructions further cause the processor to apply an associated weightage value to the parameter score of each of the plurality of parameters, to obtain a plurality of parameter weighted scores for the plurality of parameters, respectively. The processor-executable instructions further cause the processor to combine the plurality of parameter weighted scores for the plurality of parameters, to determine an overall score for the workload, and compare the overall score for workload with one or more threshold values. The processor-executable instructions further cause the processor to select a deployment type for the deployment of the workload, based on the comparison. The deployment type may be one of: a HPC deployment type, a hybrid deployment type, and a cluster deployment type.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for deploying a workload, in accordance with some embodiments of the present disclosure.

FIG. 2 is a functional block diagram of a workload deploying device showing one or more modules, in accordance with some embodiments.

FIG. 3 illustrates a flowchart of a method of deploying a workload, in particular, a method of selecting a deployment model for the workload, in accordance with some embodiments.

FIG. 4 is a Table-1 including predefined questionnaire corresponding to each sub-parameter of the set of sub-parameters, in accordance with some embodiments.

FIG. 5 illustrates a flowchart of a method of deploying a workload, in particular, a method of selecting a deployment type for the workload, in accordance with some embodiments.

FIG. 6 is a Table-2 including predefined questionnaire corresponding to each sub-parameter of the set of sub-parameters, in accordance with some embodiments.

FIG. 7 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject matter relates to a method and system for deploying a workload, for example, on one or both of a cloud computing device or on-premise devices. The method of the present subject matter may be carried out in two stages. In the first stage, a recommendation as to selecting a deployment model may be generated, and in the second stage, a method as to how to deploy the workload (i.e. deployment type) may be generated. For the first stage, a detailed analysis of the workload and requirements (for example, requirements of an organization) is considered for selecting a deployment model. For the second stage, computing requirements, storage, and some parameters are considered for distinguishing between the deployment type.

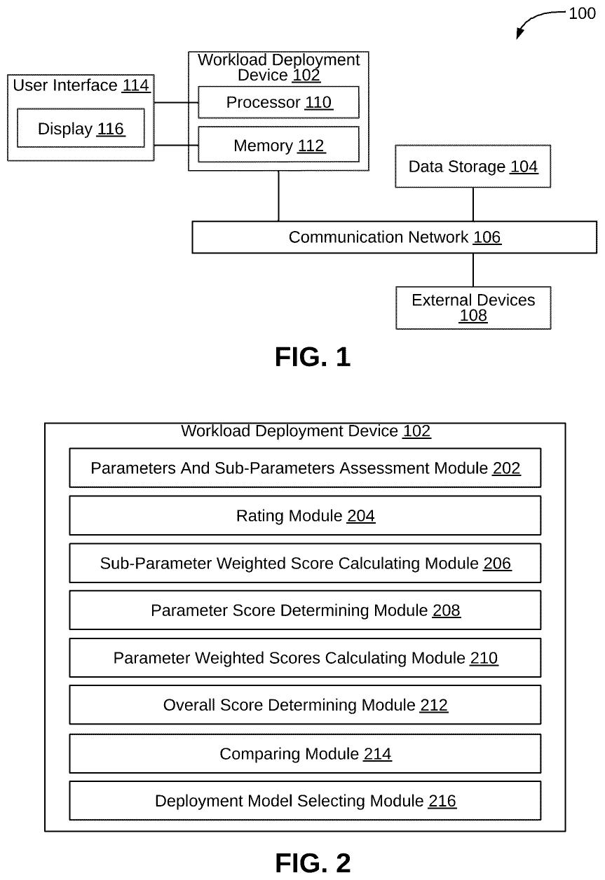

Referring now to FIG. 1, a block diagram of an exemplary system 100 for deploying a workload is illustrated, in accordance with some embodiments of the present disclosure. The system 100 may implement a workload deployment device 102. Further, the system 100 may include a data storage 104. In some embodiments, the data storage 104 may store at least some of the data related to the workload. The workload deployment device 102 may be a computing device having data processing capability. In particular, the workload deployment device 102 may have the capability for selecting a deployment model for the deployment of the workload and selecting a deployment type for the deployment of the workload. Examples of the workload deployment device 102 may include, but are not limited to a desktop, a laptop, a notebook, a netbook, a tablet, a smartphone, a mobile phone, an application server, a web server, or the like.

Additionally, the workload deployment device 102 may be communicatively coupled to an external device 108 for sending and receiving various data. Examples of the external device 108 may include, but are not limited to, a remote server, digital devices, and a computer system. The workload deployment device 102 may connect to the external device 108 over a communication network 106. The workload deployment device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108.

The workload deployment device 102 may be configured to perform one or more functionalities that may include assessing a plurality of parameters associated with a workload and a set of sub-parameters associated with each of the plurality of parameters associated with the workload, corresponding to a deployment model selection. The one or more functionalities may further include (for each parameter of the plurality of parameters, corresponding to the deployment model selection) obtaining a rating assigned to each sub-parameter of the set of sub-parameters associated with the parameter, and applying an associated weightage value to the rating assigned to each sub-parameter of the set of sub-parameters, to determine a sub-parameter weighted score for each sub-parameter of the set of sub-parameters. The one or more functionalities may further include (for each parameter of the plurality of parameters, corresponding to the deployment model selection) combining a set of sub-parameter weighted scores corresponding to the set of sub-parameters, to determine a parameter weighted score for the parameter. The one or more functionalities may further include combining a plurality of parameter weighted scores for the plurality of parameters, to determine an overall score for the workload, comparing the overall score for workload with one or more threshold values. The one or more functionalities may further include selecting a deployment model for the deployment of the workload, based on the comparison, wherein the deployment model is one of: an on-premise deployment model, a hybrid deployment model, and a cloud deployment model.

To perform the above functionalities, the workload deployment device 102 may include a processor 110 and a memory 112. The memory 112 may be communicatively coupled to the processor 110. The memory 112 stores a plurality of instructions, which upon execution by the processor 110, cause the processor 110 to perform the above functionalities. The system 100 may further include a user interface 114 which may further implement a display 116. Examples may include, but are not limited to a display, keypad, microphone, audio speakers, vibrating motor, LED lights, etc. The user interface 114 may receive input from a user and also display an output of the computation performed by the workload deployment device 102.

Referring now to FIG. 2, a block diagram of the workload deployment device 102 showing one or more modules is illustrated, in accordance with some embodiments. In some embodiments, the workload deployment device 102 may include a parameters and sub-parameters assessment module 202, a rating module 204, a sub-parameter weighted score calculating module 206, a parameter score determining module 208, a parameter weighted scores calculating module 210, a overall score determining module 212, a comparing module 214, and a deployment model selecting module 216.

The parameters and sub-parameters assessment module 202 may be configured to assess a plurality of parameters associated with a workload and a set of sub-parameters associated with each of the plurality of parameters associated with the workload, corresponding to a deployment model selection. The plurality of parameters may include a ‘workload analysis’ parameter, a ‘budget for the system’ parameter, a ‘data security and compliance’ parameter, a ‘flexibility in High Performance Computing (HPC) system’ parameter, a ‘level of control over system’ parameter, and a ‘job’ parameter. Further, the set of sub-parameters associated with the ‘workload analysis’ parameter may include a ‘workload type’ sub-parameter, a ‘throughput and bandwidth’ sub-parameter, and a ‘response time and latency’ sub-parameter. The set of sub-parameters associated with the ‘budget for the system’ parameter may include a ‘capital expenditure’ sub-parameter, an ‘operating cost’ sub-parameter, and a ‘budget projections’ sub-parameter. The set of sub-parameters associated with the ‘data security and compliance’ parameter may include a ‘control over security’ sub-parameter, a ‘data sovereignty’ sub-parameter, and a ‘security measures’ sub-parameter. The set of sub-parameters associated with the ‘flexibility in HPC system’ parameter may include a ‘customizable resources’ sub-parameter, and a ‘resource scalability’ sub-parameter. The set of sub-parameters associated with the ‘level of control over system’ parameter may include a ‘control over system’ sub-parameter, and a ‘resource monitoring’ sub-parameter. The set of sub-parameters associated with the ‘job’ parameter may include a ‘job execution time’ sub-parameter, and a ‘failed jobs’ sub-parameter.

The rating module 204 may be configured to obtain a rating assigned to each sub-parameter of the set of sub-parameters associated with the parameter, for each parameter of the plurality of parameters, corresponding to the deployment model selection. For example, the rating assigned to each sub-parameter of the set of sub-parameters associated with the parameter may be obtained based on a response to an associated predefined questionnaire.

The sub-parameter weighted score calculating module 206 may be configured to apply an associated weightage value to the rating assigned to each sub-parameter of the set of sub-parameters, to determine a sub-parameter weighted score for each sub-parameter of the set of sub-parameters, for each parameter of the plurality of parameters, corresponding to the deployment model selection. The parameter score determining module 208 may be configured to combine a set of sub-parameter weighted scores corresponding to the set of sub-parameters, to determine a parameter score for the parameter, for each parameter of the plurality of parameters, corresponding to the deployment model selection.

The parameter weighted scores calculating module 210 may be configured to apply an associated weightage value to the parameter score of each of the plurality of parameters, to obtain a plurality of parameter weighted scores for the plurality of parameters, respectively. The overall score determining module 212 may be configured to combine the plurality of parameter weighted scores for the plurality of parameters, to determine an overall score for the workload. The comparing module 214 may be configured to compare the overall score for workload with one or more threshold values. The deployment model selecting module 216 may be configured to select a deployment model for the deployment of the workload, based on the comparison, wherein the deployment model is one of: an on-premise deployment model, a hybrid deployment model, and a cloud deployment model.

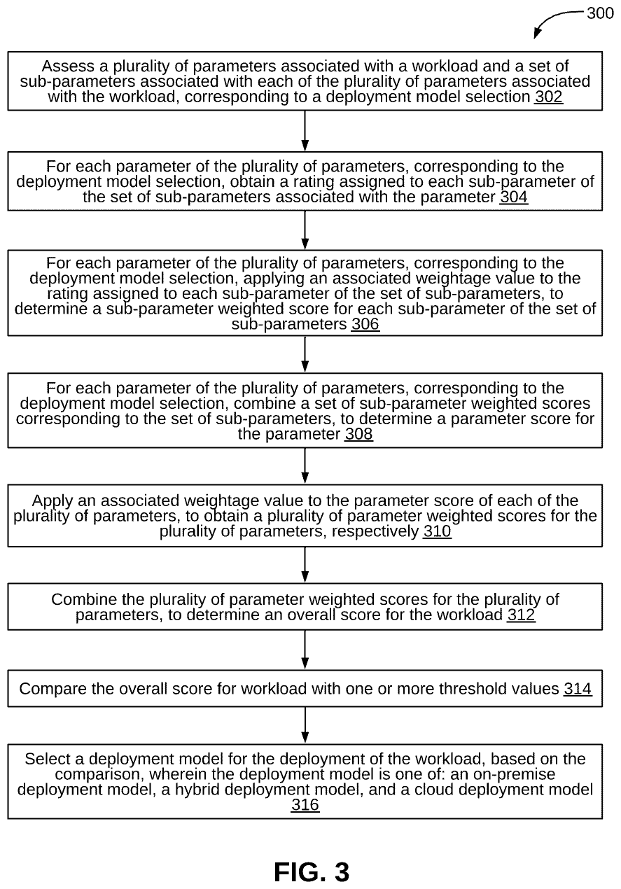

Referring now to FIG. 3, a flowchart of a method 300 of deploying a workload, in particular, a method of selecting a deployment model for the workload, is illustrated, in accordance with some embodiments. The method, for example, may be performed by the workload deployment device 102.

At step 302, a plurality of parameters associated with a workload and a set of sub-parameters associated with each of the plurality of parameters associated with the workload may be assessed, corresponding to a deployment model selection. By way of an example, the plurality of parameters associated with the workload may include a ‘workload analysis’ parameter, a ‘budget for the system’ parameter, a ‘data security and compliance’ parameter, a ‘flexibility in High Performance Computing (HPC) system’ parameter, a ‘level of control over system’ parameter, and a ‘job’ parameter. The set of sub-parameters associated with the ‘workload analysis’ parameter may include: a ‘workload type’ sub-parameter, a ‘throughput and bandwidth’ sub-parameter, and a ‘response time and latency’ sub-parameter. The set of sub-parameters associated with the ‘budget for the system’ parameter may include: a ‘capital expenditure’ sub-parameter, an ‘operating cost’ sub-parameter, and a ‘budget projections’ sub-parameter. The set of sub-parameters associated with the ‘data security and compliance’ parameter may include: a ‘control over security’ sub-parameter, a ‘data sovereignty’ sub-parameter, and a ‘security measures’ sub-parameter. The set of sub-parameters associated with the ‘flexibility in HPC system’ parameter may include: a ‘customizable resources’ sub-parameter, and a ‘resource scalability’ sub-parameter. The set of sub-parameters associated with the ‘level of control over system’ parameter may include: a ‘control over system’ sub-parameter, and a ‘resource monitoring’ sub-parameter. The set of sub-parameters associated with the ‘job’ parameter may include: a ‘job execution time’ sub-parameter, and a ‘failed jobs’ sub-parameter.

It should be noted that the plurality of parameters and the sets of sub-parameters may be assessed via an automated or a manual approach. The manual approach may be suitable when a client is aware of the High Performance Computing (HPC) system requirements. In the automated approach, an agent may be used that may automatically collect the various logs and carry out the assessment.

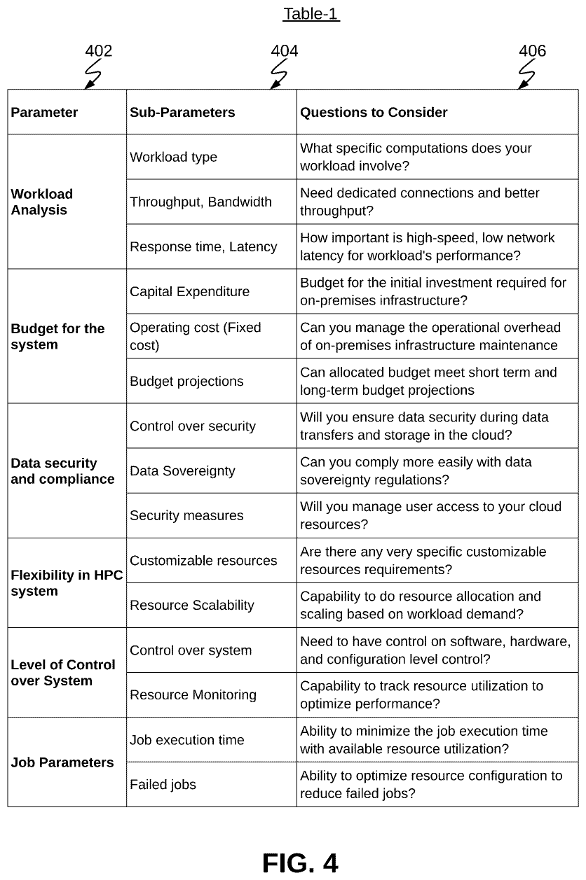

At step 304, for each parameter of the plurality of parameters, corresponding to the deployment model selection, a rating assigned to each sub-parameter of the set of sub-parameters associated with the parameter may be obtained. The rating assigned to each sub-parameter of the set of sub-parameters may be obtained based on a response to an associated predefined questionnaire. As such, for each sub-parameter, the rating may be obtained corresponding to a question based on the client requirement. Example predefined questionnaire corresponding to each sub-parameter of the set of sub-parameters are provided in a Table-1 illustrated in FIG. 4. As shown in FIG. 4, the plurality of parameters are tabulated in a Column 402, the sets of sub-parameters associated with each of the plurality of parameters are tabulated in Column 404, and the predefined questionnaire corresponding to each sub-parameter are tabulated in Column 406. For example, for the sub-parameter ‘workload type’ associated with the parameter ‘workload analysis’, the corresponding predefined questionnaire may be “What specific computations does your workload involve?”. For the sub-parameter ‘throughput, bandwidth’ associated with the parameter ‘workload analysis’, the corresponding predefined questionnaire may be “Need dedicated connections and better throughput?”, and so on. The above parameters and the sub-parameters are explained in detail in the below sections.

### ‘Workload Analysis’ Parameter

The type of workload is a critical parameter when deciding whether the workload should be deployed on-premise or cloud-based HPC. The deployment of the workloads may differ based on the characteristics and resource requirements of the workload. As mentioned above, the set of sub-parameters associated with the ‘workload analysis’ parameter may include: a ‘workload type’ sub-parameter, a ‘throughput and bandwidth’ sub-parameter, and a ‘response time and latency’ sub-parameter.

For a compute-intensive workload involving heavy computation and low latency communication between nodes, the on-premise deployment may be selected. This is because dedicated hardware provided by the on-premise deployment can be better optimized for computational tasks. However, for higher scalability requirement, cloud-based deployment may be selected. Further, for a data intensive workload that requires large scale data analysis or processing, the cloud-based deployment may be selected because of its ability to provide higher storage. However, the cloud-based deployment may not be suitable when cost and time are important factors, because of the need to transfer data transfer to the cloud. For a bursty workload, the cloud-based deployment may be selected, as it is better suited to handle the peak demands for resources. Also, the cloud-based deployment enables dynamic scale-up and scale-down. For simulation and modelling tasks with substantial computing power and memory, the on-premise deployment may be selected. For real-time workloads that need real-time processing with minimal latency, the on-premise deployment may be selected as it allows better control over network and performance. For legacy applications which are tightly integrated with on-premise systems, transitioning to the cloud may involve higher effort and cost, and therefore the on-premise deployment may be selected for these applications.

For example, in chip testing industry, complex simulation and modeling of semiconductor devices are carried out, that includes simulating behavior of transistors, circuits, and other components to assess their performance and functionality. Further, large datasets generated during chip testing need to be assessed that includes identifying potential flaws, analyzing simulation results, and validating chip performance. As such, the chip testing industry includes simulation and modelling, as well as data analysis type of workload. This kind of workload (involving simulation and modelling, data analysis) requires heavy resource utilization. Therefore, for such workload, on-premise deployment may be selected as it may provide dedicated resources and greater control to the organization's users. However, the cloud-based deployment may provide elastic resource allocation which may optimize resource utilization and allow scale-up or scale-down functionality to match the specific need of the workload testing.

The ‘workload type’ sub-parameter may be assigned a rating ‘r1’. For the ‘workload type’ sub-parameter, the factors of elasticity in resource allocation and ability to handle dynamic processing pattern may make the cloud-based deployment a better option; however, the factors of greater control on resources and customization may make the on-premise deployment a more suitable option. Therefore, a combination of both the cloud-based deployment and the on-premise deployment may be recommended for the ‘workload type’ sub-parameter.

For data movement, the on-premise deployment may be selected as it faster, incurs lower data transfer charges, and allows the organization to have direct control over the network, infrastructure, including throughput and bandwidth. This provides for predictable and consistent network performance and ensures that network resources are dedicated to chip testing without sharing to other cloud users. So, for ‘bandwidth and throughput’ sub-parameter, a rating ‘r2’ may be assigned. For the ‘bandwidth and throughput’ sub-parameter, on-premise deployment may be more efficient than cloud-based deployment.

For workloads that involve high data processing and large volume of data transfer, the on-premise deployment may provide low-latency data processing. This is a critical factor for chip testing where real time analysis is required. While cloud-based deployment is robust; however, latency can vary based on data location and network speed. For ‘response time and latency’ sub-parameter a rating ‘r3’ is assigned. On-premise deployment may be more suitable for faster response time and lower latency.

### ‘Budget for the System’ Parameter

Both the op-premise deployment and the cloud-based deployment have distinct cost structures. The budget constraints of the organizations may therefore influence the deployment model selection. As mentioned above, the set of sub-parameters associated with the budget for the system parameter may include: a ‘capital expenditure’ sub-parameter, an ‘operating cost’ sub-parameter, and a ‘budget projections’ sub-parameter. Some of the costs involved for making budgeting selection are explained below.

(1) Capital Expenditure: On-premise deployment may involve higher upfront costs incurred in hardware, infrastructure, cooling, and power. Cloud-based deployments typically follow pay-as-you-go model and resources are billed on resources usage, which can be advantageous for variable workloads. Hence, cloud-based deployments eliminate the significant upfront capital investment for organizations with budget constraints. On-premise deployments may be more cost effective for long-term investments on consistent workloads, and the value can be recovered in longer run.

(2) Fixed cost: These costs remain relatively fixed regardless of workload fluctuations.

(3) Maintenance cost: These costs include regular maintenance and costs for upgrading new hardware and software.

(4) Budget projections: The organization may opt for a higher initial on-premise deployment or predictable and scalable payment of cloud-based deployment, based on short-term and long-term budget projections.

It should be noted that a hybrid approach may be selected in scenarios where there both the on-premise deployment (for example, for consistent loads) and the cloud-based deployment (for example, for burst and peak loads) can be used. The hybrid approach minimizes upfront investment and leverages the cloud's flexibility.

For example, for the chip testing industry, due to long-term plan of chip testing HPC setup, the on-premise deployment may be selected, as the upfront cost is low and the on-premise deployment allows recovering the cost in longer run. The cloud-based deployment may be a better option for short-term HPC requirements. The ‘capital expenditure’ sub-parameter may be assigned a rating of ‘r4’. Further, as will be appreciated by those skilled in the art, the on-premise deployment may require continuous ongoing maintenance. However, cloud-based deployment may reduce these overheads. The ‘operating cost’ sub-parameter may be assigned a rating of ‘r5’. For the ‘budget projections’ sub-parameter, the on-premise deployment may be more economical as compared to the cloud-based deployment. The ‘budget projections’ sub-parameter may be assigned a rating ‘r6’.

### ‘Data Security and Compliance’ Parameter

Different deployment models may offer varying levels of control and security measures, and therefore may influence selection of the deployment models for the workloads. As mentioned above, the set of sub-parameters associated with the ‘data security and compliance’ parameter may include the ‘control over security’ sub-parameter, the ‘data sovereignty’ sub-parameter, and the ‘security measures’ sub-parameter, that are explained below.

(1) ‘Control over security’ parameter: the on-premise deployment may provide a higher degree of control over the infrastructure and therefore the organizations may implement custom security protocols and access controls as per needs. Cloud-based deployment may provide security from vendor and provide various features including firewall protection, intrusion detection and regular security updates. For example, in the chip testing industry, protection of intellectual property and sensitive data may be a top priority. The on-premise deployment may better assist in stringent measures tailored to their specific needs. The ‘control over security’ sub-parameter may be assigned a rating of ‘r7’ to consider the on-premise deployment option.

(2) ‘Data sovereignty’ sub-parameter: In the on-premise deployment, organizations may have better control over the location where the data resides, which can be important for compliance with data sovereignty regulations. The cloud-based deployments may be required to comply with compliance certifications that the organizations may need to be updated with. The data that is stored on the on-premise infrastructure of the organization complies with regional and industry-specific regulations. Therefore, for chip testing industry, it is more reliable to keep the data stored through on-premise deployment rather than on cloud-based deployment which requires careful planning and considerations for cloud provider options. However, the cloud-based deployment can offer more reliability for data safety, which will be tedious in an on-premise deployment. The ‘data sovereignty’ sub-parameter may be assigned rating ‘r8’, considering the sensitiveness of data.

(3) ‘Security measures’ sub-parameter: In on-premise deployments, organizations may implement their own security protocols, encryption, and authorizations. In cloud-based deployments, the organizations may be required to manage the security and manage access controls. Both on-premise deployment and cloud-based deployment may provide sufficient levels of security. The ‘security measures’ sub-parameter may be assigned a rating of ‘r9’.

It should be noted that the hybrid deployment model may offer a middle ground, such that the organizations may keep the sensitive data the on-premise deployment and may utilize the cloud-based deployment for normal processing. This combines control and security with cloud's scalability.

### ‘Flexibility of HPC System’ Parameter

Flexibility of the HPC system refers to a system's ability to adapt to changing needs, scale resources, and accommodate varying workloads. As mentioned above, the set of sub-parameters associated with the flexibility in HPC system parameter may include the customizable resources sub-parameter, and the resource scalability sub-parameter, that are explained in detail in the below sections.

(1) ‘Customizable resources’ sub-parameter: On-premise deployment may be customized to meet the specific requirements and organizations can have complete control over the hardware, software, and configuration. Cloud-based deployment may provide specialized virtual machine (VM) configurations and lesser options of customizations. For example, for the chip testing industry, the cloud-based deployment may provide the HPC systems with latest advancements in EDA related to logic synthesis, function verification, heat dissipation, etc. However, the on-premise deployment may provide critical customization and specialized equipment. For the ‘customizable resources’ sub-parameter, a rating ‘r10’ may be assigned to consider cloud-based deployment for advanced technology in combination with some specialized hardware requirements through on-premise deployment.

(2) ‘Resource scalability’ sub-parameter: Cloud-based deployment may provide better resource scalability. As such, organizations can easily scale up resources during peak demands and scale down during idle periods. Thus, cloud-based deployment may offer better dynamic provisioning to match the computing requirements. For the ‘resource scalability’ sub-parameter, cloud-based deployment may provide on demand scaling of servers, storage, and networking during peak periods. For the ‘resource scalability’ sub-parameter, a rating of ‘r11’ may be assigned.

Further, it should be noted that the hybrid deployment combines the benefits of both the on-premise deployment and the cloud-based deployment, where organizations can maintain core on-premise deployment for steady workloads and burst to the cloud-based deployment for peak demands, to thereby optimize the performance and costs.

### ‘Level of Control Over System’ Parameter

Different deployment models offer varying degrees of control. As mentioned above, the set of sub-parameters associated with the level of ‘control over system’ parameter may include the ‘control over system’ sub-parameter, and the ‘resource monitoring’ sub-parameter, that are explained in detail in the below sections.

(1) ‘Control over system’ sub-parameter: On-premise deployment provides higher level of control, and therefore organizations can have full authority over hardware, software, configurations, security measures and access controls. Cloud-based deployment may offer shared responsibility for security and configuration. Depending on the type of workload, it may be important for some organizations to have complete control over the systems, which may not be possible in cloud-based deployments. Further, cloud providers may provide lesser granular control over hardware. However, cloud-based deployment may offer ease of resource provisioning. For example, for the chip testing industry, where precision and reliability are essential, the level of control in the on-premise deployment may be a preferred option than a relatively restricted cloud-based deployment. An organization can have better autonomy over hardware configurations and resource allocation policies than cloud deployments. For the ‘control over system’ sub-parameter, a rating ‘r12’ may be assigned.

(2) ‘Resource monitoring’ sub-parameter: On premise deployment may allow real time performance monitoring and enabling quick response to performance issues or capacity planning. In cloud-based deployment, performance metrics, logs and dashboards may be available, however, there may be lags in data updation. As such, organizations need to decide if they need real time monitoring or historical analysis, and assess whether specific performance metrics are available as per their requirements. For the ‘resource monitoring’ sub-parameter, both the on-premise deployment and cloud-based deployment may offer sufficient level of control in monitoring the hardware and software at granular level. For the ‘resource monitoring’ sub-parameter, a rating of ‘r13’ may be assigned.

A hybrid deployment may offer a balance between control and resource provisioning. For example, sensitive or mission critical workloads may be stored on the on-premise deployment to maintain better control, and cloud-based deployment may be used for flexible resource scaling.

### ‘Job’ Parameter

As mentioned above, the set of sub-parameters associated with the ‘job’ parameter may include a ‘job execution time’ sub-parameter, and a ‘failed jobs’ sub-parameter, that are explained in detail in the below sections.

(1) ‘Job execution time’ sub-parameter: Job execution time is the time required to complete a job, in particular, a HPC job. On-premise deployment may provide more consistent performance due to dedicated hardware; however, its limited scalability may lead to resource contention and longer job queues. Cloud-based deployment may offer elasticity to scale based on dynamic requirements, which can lead to faster job execution during peak loads. For example, for the chip testing industry, timely results may impact product development cycle. On-premise deployment may provide dedicated hardware and networking, which will provide lower latency and faster execution speed. For the ‘job execution time’ sub-parameter, a rating ‘r14’ may be assigned.

‘Failed jobs’ sub-parameter: Failed jobs can significantly impact productivity and resource utilization. On-premise deployment may provide dedicated hardware and infrastructure, which can result in better control over hardware failures and system stability. However, software issues and misconfiguration may lead to failed jobs. Cloud-based deployment may abstract hardware details, which can reduce hardware related failures. However, issues related to cloud infrastructure or misconfiguration may lead to job failures. On-premise deployment may allow direct control over software and hardware for a skilled person in case of any misconfiguration or job failure and organizations can employ rigorous quality control measures to troubleshoot issues promptly. Although cloud-based deployment may provide Service-Level Agreements (SLAs) that guarantee a certain level of availability. For the ‘failed job’ sub-parameter, a rating ‘r15’ may be assigned.

Referring back to FIG. 3, at step 306, for each parameter of the plurality of parameters, corresponding to the deployment model selection, an associated weightage value may be applied to the rating assigned to each sub-parameter of the set of sub-parameters, to determine a sub-parameter weighted score for each sub-parameter of the set of sub-parameters. The associated weightage value for each sub-parameter may be predefined or pre-identified. The associated weightage value may be multiplied with the rating (i.e. sub-parameter rating) assigned to each sub-parameter, to determine the sub-parameter weighted score for each sub-parameter of the set of sub-parameters.

For example, for the ‘workload analysis’ parameter, a weightage value w1 may be applied to the ‘workload type’ sub-parameter, a weightage value w2 may be applied to the ‘throughput and bandwidth’ sub-parameter, and a weightage value w3 may be applied to the ‘response time and latency’ sub-parameter. For the ‘budget for the system’ parameter, a weightage value w4 may be applied to the ‘capital expenditure’ sub-parameter, a weightage value w5 may be applied to the ‘operating cost’ sub-parameter, and a weightage value w6 may be applied to the ‘budget projections’ sub-parameter. For the ‘data security and compliance’ parameter, a weightage value w7 may be applied to the ‘control over security’ sub-parameter, a weightage value w8 may be applied to the ‘data sovereignty’ sub-parameter, and a weightage value w9 may be applied to the ‘security measures’ sub-parameter. For the ‘flexibility in HPC system’ parameter, a weightage value w10 may be applied to the ‘customizable resources’ sub-parameter, and a weightage value w11 may be applied to the ‘resource scalability’ sub-parameter. For ‘level of control over system’ parameter, a weightage value w12 may be applied to the ‘control over system’ sub-parameter, and a weightage value w13 may be applied to the ‘resource monitoring’ sub-parameter. For the ‘job’ parameter, a weightage value w14 may be applied to the ‘job execution time’ sub-parameter, and a weightage value w15 may be applied to the ‘failed jobs’ sub-parameter.

For each sub-parameter, an associated questionnaire may be available to obtain the rating. The rating may be assigned based on the suitability of deployment model as per business or technical requirements. For example, lower ratings may be assigned for on-premise deployment and higher ratings for cloud-based deployments. It should be noted that in some embodiments, when the sub-parameter weighted score for a sub-parameter is between 1 to 3, the on-premise deployment model may be suitable. When the sub-parameter weighted score for a sub-parameter is between 4 to 6, the hybrid deployment model may be suitable. When the sub-parameter weighted score for a sub-parameter is between 7 to 10, the cloud-based deployment model may be suitable.

At step 308, for each parameter of the plurality of parameters, corresponding to the deployment model selection, a set of sub-parameter weighted scores corresponding to the set of sub-parameters may be combined, to determine a parameter weighted score for the parameter. In other words, sub-parameter weighted scores for each sub-parameter of the set of sub-parameters may be summed to determine the parameter weighted score for the parameter. As such, the parameter weighted score for each parameter can be calculated using Equation (1), as below:

$$Parameter Weighted Score = {\sum }_{i = 1}^{n} ( Subparameter rating ⋆ weightage value ) \qquad Equation ( 1 )$$

where n is number of sub-parameters for the parameter

In particular, a parameter weighted score for the ‘workload analysis’ parameter may be calculated as:

$$Weighted score of ‘ workload analysis ’ = ( r 1 ⋆ w 1 ) + ( r 2 ⋆ w 2 ) + ( r 3 ⋆ w 3 ) = p 1$$

A parameter weighted score for the ‘budget for the system’ parameter may be calculated as:

$$Weighted score of ‘ budgets for the system ’ = ( r 4 * w 4 ) + ( r 5 * w 5 ) + ( r 6 * w 6 ) = p 2$$

A parameter weighted score for the ‘data security and compliance’ parameter may be calculated as:

$$Weighted score of ‘ data security and compliance ’ = ( r 7 * w 7 ) + ( r 8 * w 8 ) + ( r 9 * w 9 ) = p 3$$

A parameter weighted score for the ‘flexibility in HPC system’ parameter may be calculated as:

$$Weighted score of ‘ flexibility in HPC system ’ = ( r 10 * w 10 ) + ( r 11 * w 11 ) = p 4$$

A parameter weighted score for the ‘level of control over system’ parameter may be calculated as:

$$Weighted score of ‘ level of control over system ’ = ( r 12 * w 12 ) + ( r 13 * w 13 ) = p 5$$

A parameter weighted score for the ‘job’ parameter may be calculated as:

$$Weighted score of ‘ job ’ = ( r 14 * w 14 ) + ( r 15 * w 15 ) = p 6$$

At step 310, an associated weightage value may be applied to the parameter score of each of the plurality of parameters, to obtain a plurality of parameter weighted scores for the plurality of parameters, respectively. As such, the associated weightage value for each parameter may be multiplied with the parameter score, to determine the parameter weighted score, for each parameter. For example, a weightage value w16 may be applied to the ‘workload analysis’ parameter, a weightage value w17 may be applied to the ‘budget for the system’ parameter, a weightage value w18 may be applied to the ‘data security and compliance’ parameter, a weightage value w19 may be applied to the ‘flexibility in High Performance Computing (HPC) system’ parameter, a weightage value w20 may be applied to the ‘level of control over system’ parameter, and a weightage value w21 may be applied to the and a ‘job’ parameter.

At step 312, the plurality of parameter weighted scores for the plurality of parameters may be combined, to determine an overall score for the workload. In other words, the plurality of parameter weighted scores for the plurality of parameters may be summed, to determine the overall score for the workload. As such, the overall score for the workload can be calculated using Equation (2), as below:

$$Overall score for workload = {\sum }_{i = 1}^{m} ( Parameter score * weighted value ) , \qquad Equation ( 2 )$$

where m is number of parameters

As such, the overall score for the workload may be calculated as:

$$Overall score for the workload = ( p 1 * w 16 ) + ( p 2 * w 17 ) + ( p 3 * w 18 ) + ( p 4 * w 19 ) + ( p 5 * w 20 ) + ( p 6 * w 21 )$$

At step 314, the overall score for workload may be compared with one or more threshold values. At step 316, a deployment model may be selected for the deployment of the workload, based on the comparison. In some embodiments, the deployment model may be one of: the on-premise deployment model, the hybrid deployment model, and the cloud deployment model.

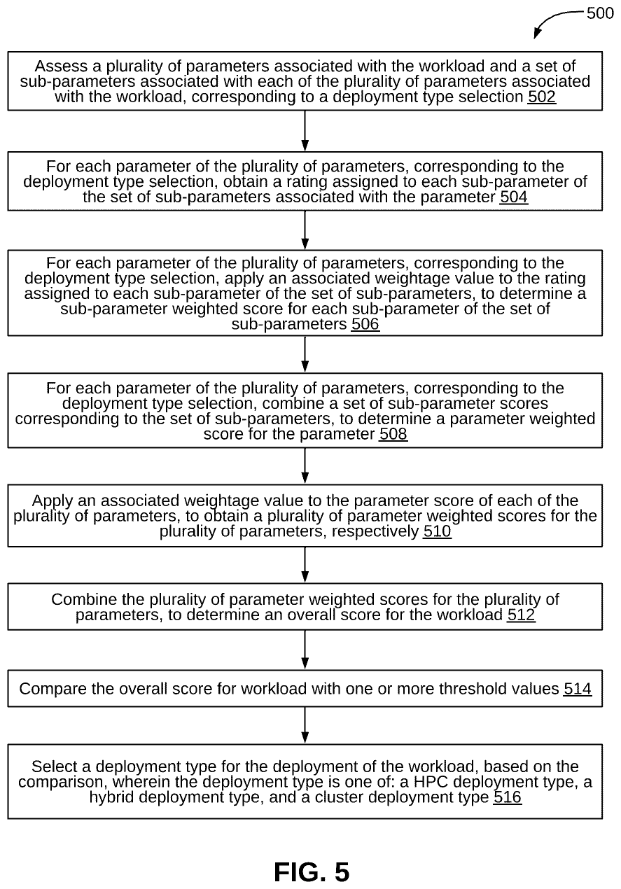

As mentioned above, the first stage of selecting the deployment model may follow with the second stage of deployment of selecting deployment type, for example, based on computing requirements, storage, and other parameters. A method of deploying a workload, in particular, a method of selecting a deployment type for the workload is explained via FIG. 5.

Referring to FIG. 5, a flowchart of a method 500 of deploying a workload, in particular, a method of selecting a deployment type for the workload is illustrated, in accordance with some embodiments. The method 500, for example, may be performed by the workload deployment device 102.

At step 502, a plurality of parameters associated with the workload and a set of sub-parameters associated with each of the plurality of parameters associated with the workload, corresponding to a deployment type selection may be assessed. In some embodiments, the plurality of parameters may include a ‘nature of HPC jobs’ parameter, a ‘cluster configuration’ parameter, a ‘resource allocation’ parameter, a ‘job scheduling’ parameter, and a ‘software stack or libraries’ parameter. By way of an example, the set of sub-parameters associated with the ‘nature of HPC jobs’ parameter may include a ‘job type’ sub-parameters, and an ‘execution frequency’ sub-parameters. The set of sub-parameters associated with the ‘cluster configuration’ parameter may include an ‘accelerator requirements’ sub-parameter, and a ‘storage system’ sub-parameter. The set of sub-parameters associated with the ‘resource allocation’ parameter may include a ‘CPU and memory requirements’ sub-parameter, a ‘GPU and FPA requirements’ sub-parameter, and ‘network’ sub-parameter. The set of sub-parameters associated with the ‘job scheduling’ parameter may include a ‘job priority’ sub-parameter, and a ‘job execution time’ sub-parameter. The set of sub-parameters associated with the ‘software stack or libraries’ parameter may include a ‘parallel program execution library’ sub-parameter, and a ‘customized library’ sub-parameter.

It should be noted that the plurality of parameters and the sets of sub-parameters may be assessed via an automated or a manual approach. The manual approach may be suitable when a client is aware of the HPC system requirements. In the automated approach, an agent may be used that may automatically collect the various logs and carry out the assessment.

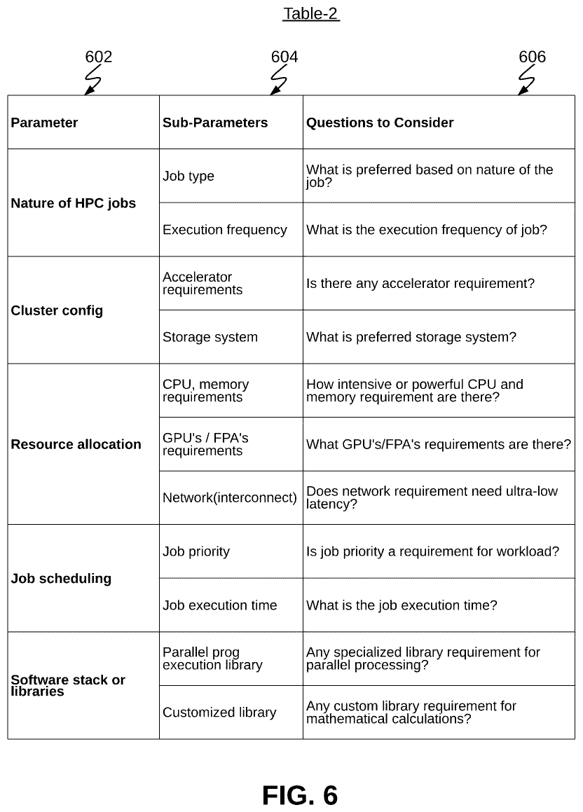

At step 504, for each parameter of the plurality of parameters, corresponding to the deployment type selection, a rating may be assigned to each sub-parameter of the set of sub-parameters associated with the parameter. The rating assigned to each sub-parameter of the set of sub-parameters may be obtained based on a response to an associated predefined questionnaire. As such, for each sub-parameter, the rating may be obtained corresponding to a question based on the client requirement. Example predefined questionnaire corresponding to each sub-parameter of the set of sub-parameters are provided in a Table-2 illustrated in FIG. 6. As shown in FIG. 6, the plurality of parameters are tabulated in a Column 602, the sets of sub-parameters associated with each of the plurality of parameters are tabulated in Column 604, and the predefined questionnaire corresponding to each sub-parameter are tabulated in Column 606. For example, for the ‘job type’ sub-parameter associated with the ‘nature of HPC jobs’ parameter, the associated questionnaire may be “What is preferred based on nature of the job?”; for the ‘execution frequency’ sub-parameter associated with the ‘nature of HPC jobs’ parameter, the associated questionnaire may be “What is the execution frequency of job?”, and so on. The parameters and the sub-parameters are explained in detail in the below sections.

### ‘Nature of HPC Job’ Parameter

As mentioned above, the set of sub-parameters associated with the ‘nature of HPC jobs’ parameter may include the ‘job type’ sub-parameter and the ‘execution frequency’ sub-parameter, that are explained in the below sections.

(1) ‘Job type’ sub-parameter: The job type sub-parameter may highlight the fundamental differences in nature of tasks performed by HPC system and cluster jobs. HPC jobs may be oriented towards computationally intensive scientific simulations and custom algorithms. The cluster jobs may revolve around data processing, batch processing, and leveraging big data frameworks for analytics. As will be appreciate, two types of workloads may exist on the HPC—the first being high throughput type jobs where virtual machines can work independently without need to interact with each other, for example, financial services, data analyst, etc.; the second being tightly coupled workload where virtual machines work together and are interdependent for carrying out workload analysis, for example, simulation and analysis, oil and gas exploration, etc. This type of workload requires low latency, fast storage, and data transfer in-between the virtual machines and high bandwidth. For example, in the chip testing industry, simulation and modelling as well as data analysis type of workload are involved. So, we will be considering both the scenarios. For the simulation and modelling in the chip testing industry, the job type may be high throughput, as it includes simulating behavior of transistors, circuits, and other components. Further, the simulation tasks may be computationally intensive and involve high level of complexity. Such jobs can be efficiently done on HPC. For the data analysis job, where real-time data ingestion occurs, such type of jobs can be deployed on cluster. For the ‘job type’ sub-parameter, a rating ‘rj1’ may be assigned.

(2) ‘Execution frequency’ sub-parameter: This sub-parameter relates to how often a particular computing job or task needs to be executed. In HPC, a job may be executed with a lower to moderate frequency when it involves computations with complex scientific simulations. A job in a cluster may be executed at high frequency, due to batch processing and jobs oriented towards handling continuously streaming data. The ‘execution frequency’ sub-parameter may be assigned a rating ‘rj2’.

### ‘Cluster Configuration’ Parameter

As mentioned above, the set of sub-parameters associated with the ‘cluster configuration’ parameter may include an ‘accelerator requirements’ sub-parameter, and a ‘storage system’ sub-parameter, that are explained in the below sections.

(1) ‘Accelerator requirements’ sub-parameter: This refers to the need for specialized hardware accelerators to enhance computational capabilities. In HPC, accelerators are needed in scientific simulations, molecular modelling, etc., and significantly enhance the performance of parallel computation. A Dataproc job may not require accelerators, as these rely on inherent parallelism of distributed data processing frameworks. For example, for simulation and modelling in the chip testing industry, the job type may include simulation of transistors, circuits, and other components and such jobs may need accelerators. For the data analysis job, inherent parallelism may be enough to carry out computation. A rating ‘rj3’ may be assigned to the ‘accelerator requirements’ sub-parameter.

(2) ‘Storage system’ sub-parameter: This sub-parameter relates to storage and fast read and write to local or distributed storage. A HPC job may prioritize high speed storage optimized for parallel computing, even the file systems, provide low-latency and high-throughput access to large data. A cluster deployment may be for analyzing large datasets, and storage solutions like Hadoop Distributed File System (HDFS) can easily manage such jobs. For the ‘storage system’ sub-parameter, simulation and analysis job may be efficiently deployed on HPC for parallel file access and low latency data transfer between nodes. However, data analysis may be performed on cluster deployment where only data processing is a priority. A rating ‘rj4’ may be assigned to the ‘storage system’ sub-parameter.

### ‘Resource Allocation’ Parameter

As mentioned above, the set of sub-parameters associated with the ‘resource allocation’ parameter may include the ‘CPU and memory requirements’ sub-parameter, the ‘GPU and FPA requirements’ sub-parameter, and the ‘network’ sub-parameter, that are explained in the below sections.

(1) ‘CPU and memory requirements’ sub-parameter; Both HPC and cluster jobs may utilize CPU and memory resources, the distinction lying in their intensity and purpose. The HPC jobs may be CPU-intensive, and often require powerful processor and subsequential memory for simulations. The cluster job may focus on distributed data processing, where CPU and memory resources are balanced across nodes to efficiently handle large scale data operations. For example, for the chip testing industry, simulation and analysis job may demand high CPU and memory requirements, while the data analysis task may work on a balanced system. As rating ‘rj5’ may be assigned to ‘CPU and memory requirements’ sub-parameter, assuming a simulation job may need more resources to improvise the performance of this workload analysis.

(2) ‘GPU and FPA requirements’ sub-parameter: The GPU and FPA requirements may differ in HPC and cluster loads. HPC may demand high end GPUs and precise FPA for scientific simulations. The cluster deployment may prioritize mostly CPU based processing and need low precision FPA. A rating ‘rj6’ may be assigned to the ‘GPU and FPA requirements’ sub-parameter.

(3) ‘Network’ sub-parameter: The network requirements for the HPC and cluster may differ in terms of latency sensitivity. The HPC clusters demand extremely low-latency, high bandwidth network support to support parallel computing, and they may achieve it using InfiniBand. These are effective in efficient node to node communication. The cluster deployment may focus on efficient data movement, shuffling, and dynamic scaling. A rating ‘rj7’ may be assigned to the ‘network’ sub-parameter.

### ‘Job Scheduling’ Parameter

As mentioned above, the set of sub-parameters associated with the ‘job scheduling’ parameter may include a ‘job priority’ sub-parameter, and a ‘job execution time’ sub-parameter, that are explained below.

(1) ‘Job priority’ sub-parameter: HPC clusters may have limited computational resources and therefore job priority may be critical for time-sensitive tasks to take precedence access to resources. A job in the HPC may be assigned priority levels. Further, the HPC may have a queue management system like a cluster to prioritize and schedule a job. In both HPC and cluster deployment, effective job prioritization may be essential for resource management and optimizing cluster performance. For the chip testing industry, simulation and analysis job as well as data analysis may require job priority and if these could be easily managed on cluster, then organizations may prefer the cluster as it will be cost effective than the HPC. A rating ‘rj8’ may be assigned to the ‘job priority’ sub-parameter.

(2) ‘Job execution time’ sub-parameter: HPC jobs may be characterized by their long job execution times, which are a consequence of intricate scientific computation and high precision. While the cluster jobs may be designed for shorter execution times, focusing on efficient data processing to provide quick insights into large datasets. A rating ‘rj9’ may be assigned to the ‘job execution time’ sub-parameter. For example, cluster deployment may be used for a data analysis job, and HPC may be more suitable for simulation and analysis job.

### ‘Software Stack or Libraries’ Parameter

As mentioned above, the set of sub-parameters associated with the ‘software stack or libraries’ parameter may include a ‘parallel program execution library’ sub-parameter, and a ‘customized library’ sub-parameter, that are explained below.

(1) ‘Parallel program execution library’ sub-parameter: HPC deployment may rely on libraries to achieve high-performance parallelism for tightly coupled systems. Further, various parallel processing libraries, such as Message Passing Interface (MPI) and OpenMP may be used to keep tight-coupling and high performance for parallel applications, and to communicate and synchronize in a distributed computing environment. The cluster deployment may leverage distributed data processing and have their own libraries like Apache Hadoop and Apache Spark which help in iterative processing and faster data analytics. For the chip testing industry, there may be a clear variation for libraries used in HPC and cluster workloads. In particular, cluster deployment may be used for a data analysis job, and HPC deployment may be more reliable option for simulation and analysis job. The ‘parallel program execution library’ sub-parameter may be assigned a rating ‘rj10’.

(2) ‘Customized library’ sub-parameter: This sub-parameter may be vital in enhancing capabilities and performance of the cluster, as it allows users to implement specialized algorithms and optimize workload performance. In context of cluster deployment, customized libraries may include user defined functions or custom codes written in familiar programming language for data processing and analysis. In HPC deployment, several custom libraries may exist for complex mathematical calculations, modelling, analysis, etc. These libraries may take advantage of GPUs and FPGAs to execute complex calculations efficiently. A rating ‘rj11’ may be assigned to the ‘customized library’ sub-parameter. Simulation and analysis as well as data analysis jobs may require custom libraries and thus running them on HPC may be preferable.

Referring back to FIG. 5, at step 506, for each parameter of the plurality of parameters, corresponding to the deployment type selection, an associated weightage value may be applied to the rating assigned to each sub-parameter of the set of sub-parameters, to determine a sub-parameter weighted score for each sub-parameter of the set of sub-parameters. The associated weightage value for each sub-parameter may be predefined or pre-identified. The associated weightage value may be multiplied with the rating (i.e. sub-parameter rating) assigned to each sub-parameter, to determine the sub-parameter weighted score for each sub-parameter of the set of sub-parameters.

For example, for the ‘nature of HPC jobs’ parameter, a weightage value wj1 may be applied to the ‘job type’ sub-parameter, and a weightage value wj2 may be applied to the ‘execution frequency’ sub-parameter. For the ‘cluster configuration’ parameter, a weightage value wj3 may be applied to the ‘accelerator requirements’ sub-parameter, and a weightage value wj4 may be applied to the ‘storage system’ sub-parameter. For the ‘resource allocation’ parameter, a weightage value wj5 may be applied to the ‘CPU and memory requirements’ sub-parameter, a weightage value wj6 may be applied to the ‘GPU and FPA requirements’ sub-parameter, and a weightage value wj7 may be applied to the ‘network’ sub-parameter. For the ‘job scheduling’ parameter, a weightage value wj8 may be applied to the ‘job priority’ sub-parameter, and a weightage value wj9 may be applied to the ‘job execution time’ sub-parameter. For the ‘software stack or libraries’ parameter, a weightage value wj10 may be applied to the ‘parallel program execution library’ sub-parameter, and a weightage value wj11 may be applied to the ‘customized library’ sub-parameter.

For each sub-parameter, an associated questionnaire may be available to obtain the rating. The rating may be assigned based on the suitability of deployment type as per business or technical requirements. For example, lower ratings may be assigned for HPC deployment and higher ratings for cluster (i.e. Dataproc) deployments. It should be noted that in some embodiments, when the sub-parameter weighted score for a sub-parameter is between 1 to 3, the HPC deployment type may be suitable. When the sub-parameter weighted score for a sub-parameter is between 4 to 6, the hybrid deployment type may be suitable. When the sub-parameter weighted score for a sub-parameter is between 7 to 10, the cluster deployment type may be suitable.

At step 508, for each parameter of the plurality of parameters, corresponding to the deployment model selection, a set of sub-parameter weighted scores corresponding to the set of sub-parameters may be combined, to determine a parameter weighted score for the parameter. In other words, sub-parameter weighted scores for each sub-parameter of the set of sub-parameters may be summed to determine the parameter weighted score for the parameter. As such, the parameter weighted score for each parameter can be calculated using Equation (3), as below:

$$Parameter weighted score = {\sum }_{i = 1}^{m} ( Subparameter * weightage ) \qquad Equation ( 1 )$$

where n is number of sub-parameters

In particular, a parameter weighted score for the ‘nature of HPC jobs’ parameter may be calculated as:

$$Weighted score of ‘ nature of HPC jobs ’ = ( rj 1 * wj 1 ) + ( rj 2 * wj 2 ) = pj 1$$

A parameter weighted score for the ‘cluster configuration’ parameter may be calculated as:

$$Weighted score of ‘ cluster configuration ’ = ( rj 3 * wj 3 ) + ( rj 4 * wj 4 ) = pj 2$$

A parameter weighted score for the ‘resource allocation’ parameter may be calculated as:

$$Weighted score of ‘ resource allocation ’ = ( rj 5 * wj 5 ) + ( rj 6 * wj 6 ) + ( rj 7 * wj 7 ) = pj 3$$

A parameter weighted score for the ‘job scheduling’ parameter may be calculated as:

$$Weighted score of ‘ job scheduling ’ = ( rj 8 * wj 8 ) + ( rj 9 * wj 9 ) = pj 4$$

A parameter weighted score for the ‘software stack or libraries’ parameter may be calculated as:

$$Weighted score of ‘ software stack or libraries ’ = ( rj 10 * wj 10 ) + ( rj 11 * wj 11 ) = pj 5$$

At step 510, an associated weightage value may be applied to the parameter score of each of the plurality of parameters, to obtain a plurality of parameter weighted scores for the plurality of parameters, respectively.

As such, the associated weightage value for each parameter may be multiplied with the parameter score, to determine the parameter weighted score, for each parameter. For example, a weightage value wj12 may be applied to the ‘nature of HPC jobs’ parameter, a weightage value wj13 may be applied to the ‘cluster configuration’ parameter, a weightage value wj14 may be applied to the ‘resource allocation’ parameter, a weightage value wj15 may be applied to the ‘job scheduling’ parameter, and a weightage value wj16 may be applied to the ‘software stack or libraries’ parameter.

At step 512, the plurality of parameter weighted scores for the plurality of parameters may be combined, to determine an overall score for the workload. In other words, the plurality of parameter weighted scores for the plurality of parameters may be summed, to determine the overall score for the workload. As such, the overall score for the workload can be calculated using Equation (4), as below:

$$Overall score for workload = {\sum }_{i = 1}^{m} ( Parameter score * weighted value ) , \qquad Equation ( 4 )$$

where m is number of parameters

As such, the overall score for the workload may be calculated as:

$$Overall score for the workload = ( pj 1 * wj 12 ) + ( pj 2 * wj 13 ) + ( pj 3 * wj 14 ) + ( pj 4 * wj 15 ) + ( pj 5 * wj 16 )$$

At step 514, the overall score for workload may be compared with one or more threshold values. At step 516, a deployment type for the deployment of the workload may be selected, based on the comparison. It should be noted that the deployment type may be one of: a HPC deployment type, a hybrid deployment type, and a cluster deployment type.

It should be noted that in the HPC deployment, entire job may be executed on the HPC machine due to tightly coupled nature of jobs, which creates an interdependent environment. As such, in such deployment, virtual machines collaboratively perform tasks such as workload analysis, encompassing activities like simulation and analysis, oil and gas exploration, and so on. Further, this type of workload necessitates low latency, rapid storage capabilities, efficient data transfer between virtual machines, and a high bandwidth infrastructure to ensure optimal performance.

In contrast to the HPC deployment, the cluster deployment may involve executing the complete job on a cluster. The cluster may include a group of virtual machines (such as a Dataproc cluster in GCP). The cluster deployment may be particularly suitable for high-throughput jobs, where virtual machines operate independently without the need for extensive interaction. Examples of such jobs include those within financial services, data analysis, and related domains.

Further, in the hybrid deployment, a segment of the workload may be executed on a HPC machine leveraging its capabilities, and an independent portion may be deployed on a cluster. This diversity in deployment options allows for a tailored approach based on the specific characteristics and demands of the workload, ensuring optimal performance and resource utilization across various scenarios.

By way of an example, in the chip testing industry, one type of job may involve intricate simulation and modeling of semiconductor devices, and another type of job may include the analysis of large datasets generated during chip testing. The simulation and modeling job is tightly coupled, where virtual machines collaborate and are interdependent for workload analysis. Since such jobs cannot be divided, they are ideally suited for deployment on an HPC machine. Conversely, the large dataset analysis may be a data analysis type of job that allows virtual machines to work independently without the need for much interaction. As such, such type of job may be better suited for execution on a cluster deployment. Given that a chip manufacturing workload includes two distinct job types—one suitable for HPC deployment and the other for cluster deployment, therefore, a hybrid deployment type may be an optimal selection in such a scenario. Furthermore, if both job types necessitate tight coupling, the HPC deployment mya be preferable. However, if both job types can be executed on independent machines, the cluster deployment may be a more suitable option.

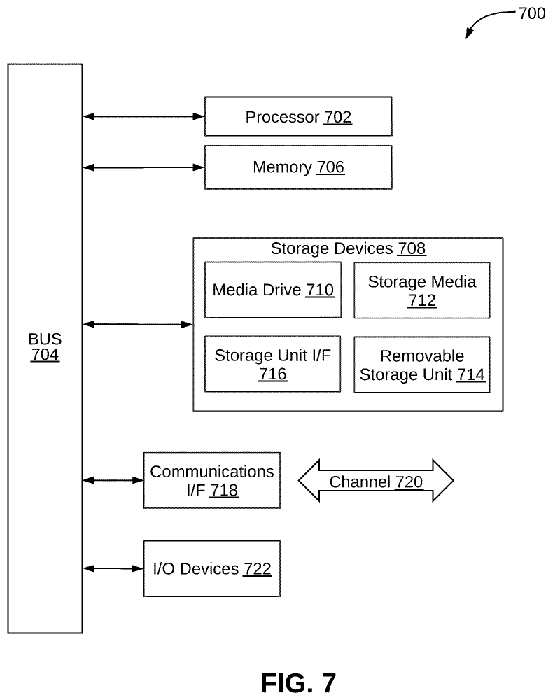

Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication media. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during the execution of instructions to be executed by processor 702. The computing system 700 may likewise include a read-only memory (“ROM”) or other static storage device coupled to bus 704 for storing static information and instructions for the processor 702.

The computing system 700 may also include storage devices 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 712 may include, for example, a hard disk, magnetic tape, flash drive, or other fixed or removable media that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro-USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

One or more techniques for selecting deployment model and deployment type for a workload are disclosed. The techniques streamline the complex decision process and open new avenues for optimizing the HPC system deployment. Further, the techniques provide for cost optimization by checking the possibility of deploying the HPC jobs on cluster or though hybrid mode. The techniques simplify the decision-making process by transforming the decision process into a calculated and strategic process, by taking into consideration various parameters and their sub-parameters.

It is intended that the disclosure and examples be considered as exemplary only, with a true scope and spirit of disclosed embodiments being indicated by the following claims.

We claim:

1. A method of deploying a workload, the method comprising:
assessing a plurality of parameters associated with a workload and a set of sub-parameters associated with each of the plurality of parameters associated with the workload, corresponding to a deployment model selection;
for each parameter of the plurality of parameters, corresponding to the deployment model selection,
obtaining a rating assigned to each sub-parameter of the set of sub-parameters associated with the parameter;
applying an associated weightage value to the rating assigned to each sub-parameter of the set of sub-parameters, to determine a sub-parameter weighted score for each sub-parameter of the set of sub-parameters; and
combining a set of sub-parameter weighted scores corresponding to the set of sub-parameters, to determine a parameter score for the parameter;
applying an associated weightage value to the parameter score of each of the plurality of parameters, to obtain a plurality of parameter weighted scores for the plurality of parameters, respectively;
combining the plurality of parameter weighted scores for the plurality of parameters, to determine an overall score for the workload;
comparing the overall score for workload with one or more threshold values; and
selecting a deployment model for the deployment of the workload, based on the comparison, wherein the deployment model is one of: an on-premise deployment model, a hybrid deployment model, and a cloud deployment model.

2. The method as claimed in claim 1, wherein the rating assigned to each sub-parameter of the set of sub-parameters associated with the parameter is obtained based on a response to an associated predefined questionnaire.

3. The method as claimed in claim 1, wherein the plurality of parameters comprises:
a ‘workload analysis’ parameter, a ‘budget for the system’ parameter, a ‘data security and compliance’ parameter, a ‘flexibility in High Performance Computing (HPC) system’ parameter, a ‘level of control over system’ parameter, and a ‘job’ parameter.

4. The method as claimed in claim 3,
wherein the set of sub-parameters associated with the ‘workload analysis’ parameter comprise: a ‘workload type’ sub-parameter, a ‘throughput and bandwidth’ sub-parameter, and a ‘response time and latency’ sub-parameter;
wherein the set of sub-parameters associated with the ‘budget for the system’ parameter comprises: a ‘capital expenditure’ sub-parameter, an ‘operating cost’ sub-parameter, and a ‘budget projections’ sub-parameter;
wherein the set of sub-parameters associated with the ‘data security and compliance’ parameter comprises: a ‘control over security’ sub-parameter, a ‘data sovereignty’ sub-parameter, and a ‘security measures’ sub-parameter;
wherein the set of sub-parameters associated with the ‘flexibility in HPC system’ parameter comprises: a ‘customizable resources’ sub-parameter, and a ‘resource scalability’ sub-parameter;
wherein the set of sub-parameters associated with the ‘level of control over system’ parameter comprises: a ‘control over system’ sub-parameter, and a ‘resource monitoring’ sub-parameter; and
wherein the set of sub-parameters associated with the ‘job’ parameter comprises: a ‘job execution time’ sub-parameter, and a ‘failed jobs’ sub-parameter.

5. The method as claimed in claim 1 further comprising:
assessing a plurality of parameters associated with the workload and a set of sub-parameters associated with each of the plurality of parameters associated with the workload, corresponding to a deployment type selection;
for each parameter of the plurality of parameters, corresponding to the deployment type selection,
obtaining a rating assigned to each sub-parameter of the set of sub-parameters associated with the parameter;
applying an associated weightage value to the rating assigned to each sub-parameter of the set of sub-parameters, to determine a sub-parameter weighted score for each sub-parameter of the set of sub-parameters; and
combining a set of sub-parameter weighted scores corresponding to the set of sub-parameters, to determine a parameter score for the parameter;
applying an associated weightage value to the parameter score of each of the plurality of parameters, to obtain a plurality of parameter weighted scores for the plurality of parameters, respectively;
combining the plurality of parameter weighted scores for the plurality of parameters, to determine an overall score for the workload;
comparing the overall score for workload with one or more threshold values; and
selecting a deployment type for the deployment of the workload, based on the comparison, wherein the deployment type is one of: a HPC deployment type, a hybrid deployment type, and a cluster deployment type.

6. The method as claimed in claim 5, wherein the rating assigned to each sub-parameter of the set of sub-parameters associated with the parameter is obtained based on a response to an associated predefined questionnaire.

7. The method as claimed in claim 5, wherein the plurality of parameters comprises:
a ‘nature of HPC jobs’ parameter, a ‘cluster configuration’ parameter, a ‘resource allocation’ parameter, a ‘job scheduling’ parameter, and a ‘software stack or libraries’ parameter.

8. The method as claimed in claim 7,
wherein the set of sub-parameters associated with the ‘nature of HPC jobs’ parameter comprise: a ‘job type’ sub-parameter, and an ‘execution frequency’ sub-parameter;
wherein the set of sub-parameters associated with the ‘cluster configuration’ parameter comprises: an ‘accelerator requirements’ sub-parameter, and a ‘storage system’ sub-parameter;
wherein the set of sub-parameters associated with the ‘resource allocation’ parameter comprises: a ‘CPU and memory requirements’ sub-parameter, a ‘GPU and FPA requirements’ sub-parameter, and ‘network’ sub-parameter;
wherein the set of sub-parameters associated with the ‘job scheduling’ parameter comprises: a ‘job priority’ sub-parameter, and a ‘job execution time’ sub-parameter; and
wherein the set of sub-parameters associated with the ‘software stack or libraries’ parameter comprises: a ‘parallel program execution library’ sub-parameter, and a ‘customized library’ sub-parameter.

9. A system for deploying a workload, the system comprising:
a processor; and
a memory communicatively coupled with the processor, the memory storing processor-executable instructions, wherein the processor-executable instructions, upon execution by the processor, cause the processor to:
assess a plurality of parameters associated with the workload and a set of sub-parameters associated with each of the plurality of parameters associated with the workload, corresponding to a deployment type selection;
for each parameter of the plurality of parameters, corresponding to the deployment type selection,
obtain a rating assigned to each sub-parameter of the set of sub-parameters associated with the parameter;
apply an associated weightage value to the rating assigned to each sub-parameter of the set of sub-parameters, to determine a sub-parameter weighted score for each sub-parameter of the set of sub-parameters; and
combine a set of sub-parameter weighted scores corresponding to the set of sub-parameters, to determine a parameter score for the parameter;
apply an associated weightage value to the parameter score of each of the plurality of parameters, to obtain a plurality of parameter weighted scores for the plurality of parameters, respectively;
combine the plurality of parameter weighted scores for the plurality of parameters, to determine an overall score for the workload;
compare the overall score for workload with one or more threshold values; and
select a deployment type for the deployment of the workload, based on the comparison, wherein the deployment type is one of: a HPC deployment type, a hybrid deployment type, and a cluster deployment type.

10. The system as claimed in claim 9, wherein the plurality of parameters comprises:
a ‘nature of HPC jobs’ parameter, a ‘cluster configuration’ parameter, a ‘resource allocation’ parameter, a ‘job scheduling’ parameter, and a ‘software stack or libraries’ parameter;
wherein the set of sub-parameters associated with the ‘nature of HPC jobs’ parameter comprise: a ‘job type’ sub-parameter, and an ‘execution frequency’ sub-parameter;
wherein the set of sub-parameters associated with the ‘cluster configuration’ parameter comprises: an ‘accelerator requirements’ sub-parameter, and a ‘storage system’ sub-parameter;
wherein the set of sub-parameters associated with the ‘resource allocation’ parameter comprises: a ‘CPU and memory requirements’ sub-parameter, a ‘GPU and FPA requirements’ sub-parameter, and ‘network’ sub-parameter;
wherein the set of sub-parameters associated with the ‘job scheduling’ parameter comprises: a ‘job priority’ sub-parameter, and a ‘job execution time’ sub-parameter; and
wherein the set of sub-parameters associated with the ‘software stack or libraries’ parameter comprises: a ‘parallel program execution library’ sub-parameter, and a ‘customized library’ sub-parameter.
